(19) United States
(12) Patent Application Publication
(10) Pub. No.: US 2012/0053387 A1
(43) Pub. Date: Mar. 1, 2012

(54) SURFACE-CLEANING METHOD AND DEVICE USING A LASER BEAM

(75) Inventors: Pierre-Yves Thro, Gif sur Yvette (FR); Michel Neu, Fontenay-Aux-Roses (FR); Jean-Marc Weulersse, Palalseau (FR)

(73) Assignee: Commissariat A L'Energie Atomique, Paris (FR)

(21) Appl. No.: 10/583,461

(22) PCT Filed: Dec. 20, 2004
(86) PCT No.: PCT/FR04/50738

§ 371 Date: Sep. 26, 2008

(30) Foreign Application Priority Data
Dec. 19, 2003 (FR) 0351153

(51) Int. Cl. A62D 3/17

(52) U.S. Cl. 588/306

(57) ABSTRACT

The invention relates to a method for the laser ablation of a surface located in a first clean area, said ablation using a laser beam which is emitted by a cavity that is associated with pumping means for supplying electromagnetic radiation to the cavity. The inventive method is characterized in that the cavity is associated with pumping means by means of an optical fibre that transmits the electromagnetic radiation such that the pumping means are maintained outside the above-mentioned cleaning area. According to the invention, the wavelength of the pump radiation is slightly attenuated in the fibre, said fibre having a length of more than 10 meters.

The present invention relates to a method and a device for cleaning a surface by means of a laser beam, especially when this surface is situated in a contaminated area.

A laser beam 104 (FIG. 1a), and generally a pulsed laser beam, is used to vaporize or sublimate particles present on the surface 100 in order to clean it. Such a method, called laser ablation, is used for different applications such as restoring structures or decontaminating surfaces.

Laser ablation may have the drawback of causing the generator 102 of the laser beam 104 to get contaminated when this beam is used to treat a wall situated in a area 106 that is contaminated, for example radioactive.

Such contamination of the generator 102 entails high cost in the treatment of the surface 100 since the generator 102 must be decontaminated in turn or even replaced if it cannot be decontaminated.

Furthermore, the pumping elements 112, namely the elements providing the energy to generate the laser beam, and the elements for cooling the generator 102 may also be contaminated, thus further increasing the cost of treating the surface 100.

Furthermore, when the treated surface is situated in a area 106 that is small or difficult to access, for example inside a piping, the application of the laser beam to this surface 100 may become complicated because of the great amount of space taken up by a laser device comprising the laser generator 102 and the pumping and cooling elements 112.

According to a second method of laser ablation described with the help of FIG. 1b, the laser generator 102 and its pumping and cooling device 112 are situated outside the contaminated area 106, with an optical fiber 105 transmitting the laser beam emitted by the generator 102 up to the surface to be treated.

Such a method has a drawback related to the limited capacity of an optical fiber for the transmission of electromagnetic radiation, especially transportation in terms of energy and power.

In fact, the energy-transmission capacities of present-day fibers are of the order of 50 millijoules for mean power values of 200 to 300 Watts while an ablation method, in order to be cost effective, may require levels of power that exceed these capacities, in particular power of over 500 Watts. It goes without saying that such power values imply transversal pumping, namely pumping that penetrates the laser material by its side wall and not by the faces through which the laser beam travels.

In one particular case, the cleaning laser beam 104 is transmitted through the optical fiber 105 via an amplifier 103 situated in the contaminated area, amplifying the laser beam before applying it to the treated surface 100, as described for example in the patents Nos. EP0475806 or EP0507641 filed on behalf of Framatome.

This particular case presents various drawbacks. It may result in the contamination of the amplifier 103 and its pumping and cooling elements 103′, thus increasing the cost of treating the surface 100.

This cost is also increased by the use of an amplifier which furthermore increases the complexity of the method.

Finally, the handling flexibility of the amplifier 103 is limited by its weight and its space requirement, as well as by the weight and the space requirement of its pumping and cooling elements 103′.

Consequently, the treatment of surfaces situated in areas that are small-sized or difficult to access is hard to achieve with such a method.

Finally, it must be emphasized that the methods that bring into play the transmission of the ablation laser ray through an optical fiber have a drawback caused by the constraint placed on the choice of the wavelength of the radiation since a fiber greatly attenuates radiation propagated at certain wavelengths, as described in detail here below.

A third method described with the help of FIG. 1c uses mirrors 107 situated in the contaminated area 100 so as to direct the laser beam 104, emitted from a non-contaminated area 108, to the treated wall 100. In fact, in this case, only the mirrors 107 and the robot arm 107′ controlling the mirrors are contaminated during the processing of the wall.

However, a method of this kind using mirrors has various drawbacks. Thus, it requires a porthole 118, situated between the contaminated area 106 and the non-contaminated area 108, in order to enable the passage of the laser beam 104.

Furthermore, this method necessitates a bulky device with mirrors that is complicated to control and requires an installation specific to the surface and/or to the installation treated.

Furthermore, it must be noted that lasers having a solid amplifier medium, especially Nd:YAG lasers, are the lasers most frequently used in laser ablation methods in combination with a system of pumping by discharge lamps; the latter is tending to be replaced by a pumping system using laser diodes.

Indeed, lasers of this type are more efficient and more compact, and require less maintenance, cooling and energy but laser diodes are costly components.

Furthermore, the pumping elements generally require cooling capacity greater than that of the laser generator with which they are associated and, consequently, the cooling circuit of the pumping elements is bulkier than the cooling circuit of the generator.

In fact, the pumping elements generally represent more than 50% of the cost of the laser device with which they are associated. When the power supply electronics and the cooling elements too are considered, these pumping, power supply and cooling elements may represent 90 percent of the cost of the laser device.

Furthermore, a second aspect of the invention results from the fact that the use of a laser using a beam of a wavelength situated in the ultraviolet (UV) range, hereinafter called a UV beam, may be particularly worthwhile for performing a laser ablation as described in the patent No. FR 9300723 or in D. Bauërle, “Laser processing and Chemistry”, 3d edition, Springer Verlag, Berlin, 2000, pp 515-516.

The latter document describes the way in which the decontamination of the surface is improved by the use of a liquid that absorbs radiation at wavelengths included in the ultraviolet range in such a way that, when this surface is subjected to laser ablation, the rapid ebullition of the droplets of liquid close to the surface improves the effectiveness of the cleaning.

However, an optical-fiber-based laser device such as the one described by means of FIG. 1b cannot be set up for an UV laser since an optical fiber transmits an UV laser beam with very low efficiency, this beam generally undergoing a loss of about 7 to 10 percent of the power transmitted per meter traveled.

In certain cases, these losses may go up to 20 percent of the power transmitted per meter t raveled, as described in “Surface Oxide removal by a XeCl laser for decontamination”, Quantum Elec., 30 (6), pp 495-500 (2000).

An UV laser beam cavity therefore needs to be introduced into the contaminated area, causing this generator to get contaminated as described with reference to FIG. 1a, thus increasing the cost of decontamination.

Furthermore, the use of an ultraviolet laser beam to decontaminate a wall may have major drawbacks, especially in a nuclear installation.

Indeed, UV lasers are generally excimer lasers, i.e. lasers using mixtures of possibly toxic gases such as fluorine or chlorine, the mixtures of gases being excited by a short and intense electrical discharge which may create electromagnetic radiation that activate alarm devices, especially those of a nuclear power plant.

The present invention proposes the use of diode-pumped solid lasers in order to overcome at least one of the above-mentioned drawbacks, i.e. it can be used to overcome at least one of the already-mentioned constraints related to:
excessive space requirement of the laser device,
limits imposed by the energy-carrying capacities of the optical fibers with respect to the laser rays,
the electromagnetic disturbances that a laser ray generator may provoke with respect to an electromagnetic radiation detection system,
high cost of a diode pumping system,
a possible attenuation of the radiation transmitted by optical fibers,
an electromagnetic disturbance in a medium sensitive to such disturbances,
use of a toxic compound in a hazardous medium,
a contamination of the laser cavity.

This is why the invention relates to a method for the laser ablation of a surface located in a cleaning area, this ablation using a laser beam emitted by a cavity associated with pumping means supplying electromagnetic radiation to the cavity, characterized in that the cavity is associated with the pumping means through an optical fiber that transmits the electromagnetic radiation such that these pumping means are kept outside the cleaning area, the pump radiation having a wavelength that is weakly attenuated in the fiber whose length is more than 10 meters.

Thus, the method according to the invention makes it possible to treat a surface by means of a laser ray generator of great handling flexibility since the pumping means and the cooling elements, which are distant from the cavity, do not have to be taken into account in order to orient the laser beam.

Furthermore, the method according to the invention limits the cost of decontamination since the pumping means that feed the laser beam are kept out of the cleaning area, thus enabling their reutilization with different laser cavities.

Finally, it is important to note that the invention can be used to make available a laser beam of high energy since this beam is not transmitted by a fiber and therefore does not undergo attenuation.

Furthermore, variants of the invention can be used to generate an UV laser beam from a laser beam of greater wavelength.

Thus, in one embodiment of the invention, it is considered that the method of decontamination of a surface by ablation uses a laser beam with a wavelength situated in the ultraviolet range. To this effect, the invention uses at least one non-linear crystal to diminish the wavelength of the laser beam in order that this wavelength may be included in the ultraviolet domain (typically ≦400 nm).

Thus, through the invention, an UV laser beam is generated from a laser beam with a distinct wavelength. At this stage it must be noted that this embodiment of the invention can be extended to the generation of a laser beam of any wavelength that cannot be transmitted satisfactorily by means of a fiber.

It is important to emphasize the fact that the use of a non-linear crystal in the treatment of a surface situated in the cleaning area is advantageous despite the low efficiency of conversion of the wavelength of a laser beam by means of a crystal.

In one embodiment, the cleaning is applied to a toxic element, for example a radioactive element, in such a way that the cleaning area is considered to be a contaminated area.

According to one embodiment, the ablation laser beam is emitted in a pulsed manner.

In one embodiment, the electromagnetic pump radiation is given continuously by the optical fiber.

According to one embodiment, with a plurality of fibers being used to transmit the pump energy, this pump energy is diffused transversally relative to the axis of the laser medium situated in the cavity.

In one embodiment, the pump energy is transmitted by fibered diodes.

According to one embodiment, the cleaned surface is radioactive.

In one embodiment, the wavelength of the laser beam generated by the cavity is modified by means of at least one non-linear crystal so that this wavelength is included in the UV domain.

According to one embodiment, the modified wavelength is smaller than 400 nm.

In one embodiment, a layer of liquid or droplets are deposited on the sublimated surface.

According to one embodiment, the mean power delivered by the laser is greater than 200 w.

The invention also relates to a device for the laser ablation of a surface situated in a cleaning area, this ablation using a laser beam emitted by a cavity associated with pumping means giving electromagnetic radiation to the cavity, characterized in that it comprises an optical fiber transmitting the electromagnetic radiation of the pumping means to the cavity according to one of the methods in accordance with one of the above claims.

The invention also relates to a robotic system for the laser ablation of a surface comprising a device according to the invention, characterized in that it comprises a hinged armed capable of carrying out a sweeping of the surface to be cleaned.

In one embodiment, the hinged arm is a robot capable of working in the presence of ambient nuclear radiation.

Other features and advantages of the invention shall appear from the description made here below, by way of a non-exhaustive illustration, with reference to the appended drawings of which:

FIGS. 1a, 1b and 1c, already described, represent known methods of surface decontamination by laser ablation,

FIG. 2 is a drawing of an ablation device according to the invention, and

FIGS. 3a and 3b are drawings of an advantageous arrangement around a laser generator of the transversal pumping means according to the invention.

FIG. 2 shows a laser ablation device 200 according to the invention, i.e. a device such that the pumping device 202 generating the laser beam is associated with this device 200 by means of a fiber 210.

Furthermore, in this embodiment, the surface to be treated is considered to be contaminated by a toxic element, i.e. an element harmful to the health of an individual, so that the ablation of the area gives rise to the formation of a contaminated area within which the environment is also toxic, and of non-contaminated area isolated from the contaminated area.

The pumping device 202 is situated in a non-contaminated area 208 protected from the contaminated and confined area 206 in which the generator 204 is situated. Thus, only be laser cavity 204 risks being contaminated in the contaminated area 206 while, in the non-contaminated area 208, the different elements of the pumping device 202, and especially its electrical power supply means and cooling means are protected from any contamination.

Furthermore, in the contaminated area 206, the entire ablation device 214 comprises, in addition to the laser cavity 204, elements such as casters 220, enabling this cavity to be shifted so that the emitted laser beam 216 has a given incidence.

Preferably, this incidence is constant and advantageously chosen to be normal to the treated surface 218. In fact, a normal incidence of this kind gives rise to higher rates of efficiency for most of the ablation methods.

The device 214 may also be associated with water-spraying means 222 to generate a presence of fine droplets of water, or a film of water, on the treated surface and thus improve the performance of the decontamination if the laser beam has a wavelength included in the UV domain as described here above.

In fact, the laser cavity 204 can emit a laser beam with a wavelength situated in the UV domain through the use of a non-linear crystal 224 converting the wavelength of the emitted laser beam 216.

In other words, the laser cavity 204 generates a laser beam 216 with a wavelength contained in the infrared domain or beyond the infrared domain, this wavelength being modified by one (or more) crystals non-linear crystals 224 before reaching the surface to be treated.

A frequency-doubling non-linear crystal, enabling the wavelength of the laser beam to be divided by 2, may be used. To divide this wavelength by 3 or 4, it is possible to use several non-linear crystals.

Thus, in considering an Nd:YAG laser emitting a laser beam with a 1.064 μm wavelength λ, it is possible to obtain a laser beam with a wavelength equal to 532 nm (visible), 355 nm (near UV) or 266 nm (UV) depending on the nature of the crystal or crystals used.

The size of the laser beam varies with the application considered; it is typically of the order of one to several millimeters.

One variant designed to make uniform the dose received by each surface element to be treated uses a homogenizer which receives the laser beam with a quasi-circular section and converts it into a square-sectioned, homogeneous beam. Such devices are known to those skilled in the art.

According to a second variant, generally used in combination with the preceding variant, a galvanometric deflection head is placed on the laser beam between, on the one hand, either the output of the laser cavity or the output of any of the devices for the shaping or homogenization of the beam if necessary and, on the other hand, the surface to be treated. A galvanometric device of this kind, which itself is also known to those skilled in the art, comprises especially two mirrors, each mounted on a galvanometer, and a device for the control of the galvanometers.

A galvanometer head of this kind is used to make the laser beam scan a square surface with a side, for example, of the order of 5 to 10 cm.

In the applications of the invention to the nuclear industry, the sublimated particles are preferably retrieved by a suction device 226 controlled from the non-contaminated area 208. This device includes a turbine 228 and a container 230 which stores the decontamination wastes.

According to one variant of the invention, usually implemented in the nuclear industry, a neutral gas is diffused in the vicinity of the ablation-treated surface so as to prevent chemical reactions such as oxidation reactions.

In one variant of the invention, an oxidizing gas is diffused in the vicinity of the ablation-treated surface so as to accelerate chemical reactions such as oxidation reactions.

According to the embodiment of the invention corresponding to FIG. 2, the laser cavity 204 comprises an Nd:YAG rod situated between a back mirror of the cavity 234 and a semi-reflecting mirror 236. This rod is surrounded by a cooling circuit 28 whose supply 240 is situated outside the contaminated area 206.

The electrical power supply (not shown) is placed in the non-contaminated area 208 and powers different components of the system such as the control circuit for the laser diodes, situated with these diodes in the pumping device 202, the cooling fluid supply 240 and its electrical power supply, the wastes suction turbine 228 and container 230 which stores the decontamination wastes and, as the case may be, the water spraying system 222.

According to the invention, the laser diodes supply the laser cavity 204 with pump energy by means of a strand 210 of optical fibers 215, the use of these optical fibers enabling this pumping to be optimized as explained further below by means of FIGS. 3a and 3b.

According to a preferred embodiment of the invention, the laser diodes give continuous pumping with a power of several kilowatts while the laser cavity creates a pulsed emission with a peak power of the order of 400 kW capable of reaching 1 MW.

It is therefore necessary to note that the beam transmitted by the optical fibers is weakly attenuated because the pump radiation may be transmitted in an 808 nm wavelength weakly attenuated in the 800 μm-core silica fiber.

At this stage, it must be emphasized that an attenuation is considered to be weak or low when it does not exceed 25 percent over the entire length of the fiber, this length being several meters or even tens of meters.

FIG. 3a shows a laser cavity 300 comprising a laser rod placed inside the cylindrical surface 302, along the axis of symmetry of this surface, possibly an activation system (not shown) which is placed with the pumping diodes in the pumping device 202, a cavity back mirror 302a, a semi-reflecting mirror 302b, connectors 306 placed at the ends of the fibers coming from the fibered laser diodes and a cooling circuit schematically represented by the inlet tube 308.

It must be noted that this cooling circuit surrounds the laser rod 302 closely in order to favor thermal transfer, and the ends 306 of the fibers coming from the pumping diodes are distributed transversely all around this laser rod 302 for improved distribution of the pump energy.

To this end, the small size of these fibers 310 enables the inflow of pumping light to be made dense in terms of luminous power per unit area of this rod 302, thanks to the small size of these fibers.

In other words, a large number of fibers may be placed around the rod.

The wavelength of the beam sent by the fiber and diodes is chosen as a function of the nature of the rod. But among several possibilities, the possibility chosen is the one corresponding to a low attenuation of the fiber. In this embodiment using an Nd:YAG rod, the wavelength of the power supply beam is around 808 nm.

One variant of the invention uses an electrode creating a major electrical field to draw and capture the particles sublimated under the effect of the laser. This particles are then stored in a container as in the case of suction.

It must be pointed out that the invention enables the use of a device provided with fibers that can have a length of over ten meters, given the low attenuation of the radiation transmitted by the fibers. This then enables the use of the ablation system in large-sized installations such as nuclear power plants.

In the preferred mode of implementation of the invention, it is provided that a hinged arm, capable of performing a scan over the surface to be cleaned, will ensure the movements of the laser cavity. This hinged arm could be a robot capable of maneuvering in the environment considered.

Depending on the variant of the invention, it can be planned that this hinged arm will also bear means to suck in the ablation residues, means to confine the ablation gases in the vicinity of the treated surface, means to shift these confinement means along the treated surface such as for example casters and/or means to inject gases to carry along the ablation residues.

In a preferred embodiment of the invention, the cleaning device is applied to the decontamination of the surfaces of a hot cell proper to the nuclear industry. In this case, the cleaning device is fixed to the end of a robotic system capable of performing a scan of the surface to be cleaned in a highly radioactive environment.

The robot arm must then be capable of working in the ambient nuclear radiation, for example by using sensors in coiled technology, such as resolvers or linear variable differential transformers (LVDT), or again optical encoders in which all the active components are transferred into a non-radioactive area. As an indication, an RX 170L type Stäubli robot is well suited to applications of this type. Its angular position sensors are resolvers and, more specifically, they are the association of a resolver with a speed 0 and a resolver with a speed n in order to obtain absolute encoding. They can take 10⁴ rads, and if need be, the same resolver can be made in a hardened version. It is electrically driven to prevent possible oil leakages.

With a square laser beam having a 2 mm side and a galvanometric head performing the scan, a square surface with a 10 cm side can be scanned within some tens of seconds to some minutes depending on the dose required at each point of the surface to be treated.

The radius of action of the RX 170L type Stäubli robot does not permit the laser beam to be kept orthogonal to the surface to be treated at all heights. Beyond about two meters, the laser head must be tilted gradually in relation to this surface in keeping the beam, at each point to be treated, for a length of time that is all the greater as the angle of incidence moves away from the normal, so that the effectively received dose remains the same.

1. Method for the laser ablation of a radioactive surface located in a contaminated cleaning area, this ablation using a laser beam emitted by a cavity associated with pumping means supplying electromagnetic radiation to the cavity, characterized in that the cavity is associated with the pumping means through an optical fiber that transmits the electromagnetic radiation such that these pumping means are kept outside the cleaning area, the pump radiation being transmitted by a fiber having a length of more than 10 meters, this transmission being done at a wavelength such that the attenuation of the pump radiation on the entire fiber is low enough for the laser beam, emitted in a pulsed manner, to deliver power with a mean value of over 200 W.

2.-3. (canceled)

4. Method according to claim 1 characterized in that the electromagnetic pump radiation is given continuously by the optical fiber.

5. Method according to one of the preceding claims, a plurality of fibers being used to transmit the pump energy, characterized in that this pump energy is diffused transversally relative to the axis of the laser medium situated in the cavity.

6. Method according to one of the preceding claims, characterized in that the pump energy is transmitted by fibered diodes.

7. Method according to one of the preceding claims, characterized in that the wavelength of the laser beam generated by the cavity is modified by means of at least one-linear crystal so that this wavelength is included in the UV domain.

8. Method according to claim 7 characterized in that the modified wavelength is smaller than 400 nm.

9. Method according to one of the claim 5 or 6 characterized in that a layer of liquid is deposited or droplets are deposited on the sublimated surface.

10. (canceled)

11. Device for the laser ablation of a surface situated in a contaminated cleaning area, this ablation using a laser beam emitted by a cavity associated with pumping means giving electromagnetic radiation to the cavity, characterized in that it comprises an optical fiber transmitting the electromagnetic radiation of the pumping means to the cavity such that the pumping means are kept outside the cleaning area, the pump radiation being transmitted by a fiber having a length of more than ten meters, this transmission being done at a wavelength such that the attenuation of the pump radiation on the entire fiber is low enough for the laser beam, emitted in a pulsed manner, to deliver power with a mean value of over 200 W.

12. Robotic system for the laser ablation of a surface comprising a device according to claim 11, characterized in that it comprises a hinged armed arm capable of carrying out a scan of the surface to be cleaned.

13. Robotic system according to claim 12, characterized in that the surface to be cleaned is in a highly radioactive environment, and in that the hinged arm is a robot capable of working in the presence of ambient nuclear radiation.
